(19) United States
(12) Patent Application Publication
(10) Pub. No.: US 2017/0192180 A1
(43) Pub. Date: Jul. 6, 2017

(54) FERRULE FOR MULTI-FIBER OPTICAL CONNECTOR

(71) Applicant: Corning Optical Communications LLC, Hickory, NC (US)

(72) Inventors: Scott Frederick Andrus, Hickory, NC (US); Andrey Kobyakov, Painted Post, NY (US); Esteban Belisario Marin, Ithaca, NY (US); Hieu Vinh Tran, Charlotte, NC (US)

(21) Appl. No.: 15/466,942

(22) Filed: Mar. 23, 2017

Related U.S. Application Data
(63) Continuation of application No. PCT/US2015/051366, filed on Sep. 22, 2015.
(60) Provisional application No. 62/056,871, filed on Sep. 29, 2014.

(51) Int. Cl. G02B 6/38; G02B 6/44

(52) U.S. Cl. CPC G02B 6/3885; G02B 6/3821; G02B 6/4403; G02B 6/3882; G02B 6/3893

(57) ABSTRACT

A ferrule includes a body extending in a longitudinal direction between a front end and a back end of the ferrule. The front end defines a first end face and a pedestal extending from the first end face in the longitudinal direction. The ferrule also includes first and second groups of micro-holes extending into the body from the first end face. Each micro-hole is configured to receive an optical fiber. The pedestal is positioned between the first and second groups of micro-holes. Optical connectors including the ferrule are also disclosed, as are cable assemblies and related methods.

### PRIORITY

This application is a continuation of PCT/US2015/051366, filed on Sep. 22, 2015, which claims the benefit of priority of U.S. Provisional Application Ser. No. 62/056,871, filed on Sep. 29, 2014. The content of both applications is relied upon and incorporated herein by reference in its entirety.

### BACKGROUND

This disclosure relates generally to optical fibers, and more particularly to ferrules for multi-fiber optical connectors, along with optical connectors, cable assemblies, and methods including such ferrules.

Optical fibers are useful in a wide variety of applications, including the telecommunications industry for voice, video, and data transmissions. In a telecommunications system that uses optical fibers, there are typically many locations where fiber optic cables that carry the optical fibers connect to equipment or other fiber optic cables. To conveniently provide these connections, optical connectors are often provided on the ends of fiber optic cables. The process of terminating individual optical fibers from a fiber optic cable is referred to as “connectorization.” Connectorization can be done in a factory, resulting in a “pre-connectorized” or “pre-terminated” fiber optic cable, or the field (e.g., using a “field-installable” connectors).

Many different types of optical connectors exist. In environments that require high density interconnects and/or high bandwidth, such as datacenters, multi-fiber optical connectors are the most widely used. One example is the multi-fiber push on (MPO) connector, which incorporates a mechanical transfer (MT) ferrule and is standardized according to TOA-604-5 and IEC 61754-7. These connectors can achieve a very high density of optical fibers, which reduces the amount of hardware, space, and effort to establish a large number of interconnects.

Despite the widespread use of MPO connectors in datacenter environments, there are still challenges/issues to address. For example, although MPO connectors may contain any even number of fibers between 4 and 24 within the same physical package, 12-fiber connectors are the most commonly used. For some applications, such as parallel optics for 40 Gps Ethernet, only 8 active fibers are needed. Conversion modules may be used to convert the unused fibers from two or more MPO connectors into usable optical links (e.g., converting 4 unused fibers from each of two MPO connectors into 8 useable optical links), but the conversion adds costs to a network. Alternatively, cable assemblies can be built with only 8-fibers terminated by an MPO connector, but the MPO connector still resembles a 12-fiber connector. In other words, it can be difficult to see with the naked eye whether 8 fibers or 12 fibers are present. This uncertainty in fiber count may result in network issues if a connector with 12 active fibers is inadvertently mated to a connector with only 8 active fibers.

Additionally, given the relatively large surface area of the front end face of the MT ferrule, which presents the optical fibers for optical coupling and serves as a contact surface during mating, there is more potential for dust, debris, or other particulates to be present and interfere with the mating. The particulates may even be large enough to result in the optical fibers prevent physical contact with the optical fibers of the mating component, thereby affecting optical performance.

Furthermore, precisely positioning the optical fibers relative to the front end face of the ferrule can be time-consuming. Many ferrules, and particularly MT ferrules for MPO connectors, are polished after inserting and securing optical fibers in micro-holes of the ferrule. The polishing is done in a manner that preferentially removes ferrule material from the front end face relative to ends of the optical fibers. Typically several polishing steps are required with polishing films, each having different abrasive characteristics, to carefully control the preferential removal of ferrule material and resulting protrusion height of the optical fibers beyond the front end face. The protrusion height must meet tight dimensional requirements to achieve effective optical coupling with mating components.

### SUMMARY

Embodiments of a ferrule for an optical connector are disclosed below. According to one embodiment, such a ferrule includes a body extending in a longitudinal direction between a front end and a back end of the ferrule. The front end defines a first end face and a pedestal extending from the first end face in the longitudinal direction. The ferrule also includes first and second groups of micro-holes extending into the body from the first end face. Each micro-hole is configured to receive an optical fiber. The pedestal is positioned between the first and second groups of micro-holes.

Optical connectors including a ferrule like that mentioned above are also disclosed, as are cable assemblies including the optical connectors.

According one embodiment, a multi-fiber cable assembly includes an optical connector and optical fibers. The optical connector has a ferrule, which itself includes a body extending along a longitudinal axis between a front end and a back end of the ferrule. The front end of the ferrule defines a first end face and a pedestal extending from the first end face in the longitudinal direction. The pedestal defines a second end face offset from the first end face. First and second groups of micro-holes extend into the body of the ferrule from the first end face, and are arranged such that the pedestal is positioned between the first and second groups of micro-holes. The optical fibers are each received in one of the micro-holes and each extend past the first end face at least to a plane including the second end face.

Methods of installing a ferrule, such as one of the ferrules mentioned above, on a plurality of optical fibers are also disclosed. According to one such method, the ferrule includes a body extending in a longitudinal direction between a front end and a back end of the ferrule, first and second groups of micro-holes extending into the body from a first end face defined by the front end, and a pedestal extending from the first end face in the longitudinal direction. The pedestal is positioned between the first and second groups of micro-holes and defines a second end face offset from the first end face in the longitudinal direction. The method involves inserting the optical fibers into the back end of the ferrule and through the first and second groups of micro-holes such that the optical fibers extend beyond the first end face. A reference surface is contacted with the optical fibers and with the second end face of the pedestal. While the optical fibers and second end face remain in contact with the reference surface, the optical fibers are secured in the ferrule. Finally, the second end face is polished to remove material of the pedestal so that ends of the optical fibers protrude past a transverse plane including the second end face.

Additional features and advantages will be set forth in the detailed description which follows, and in part will be readily apparent to those skilled in the technical field of optical communications. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 a perspective view of an example of a fiber optic connector;

FIG. 2 is an exploded perspective view of the fiber optic connector of FIG. 1;

FIG. 3 is a perspective view of an alternative embodiment of a ferrule for a fiber optic connector, such as the fiber optic connector of FIG. 1;

FIG. 4 is a cross-sectional view of the ferrule of FIG. 3; and

FIG. 5 includes schematic views of alternative embodiments of a ferrule for a fiber optic connector.

### DETAILED DESCRIPTION

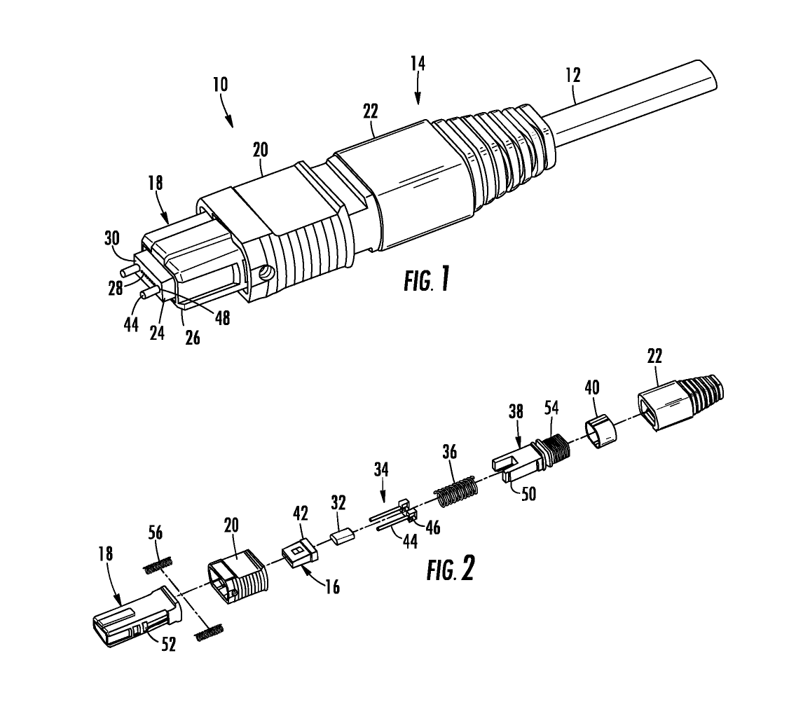

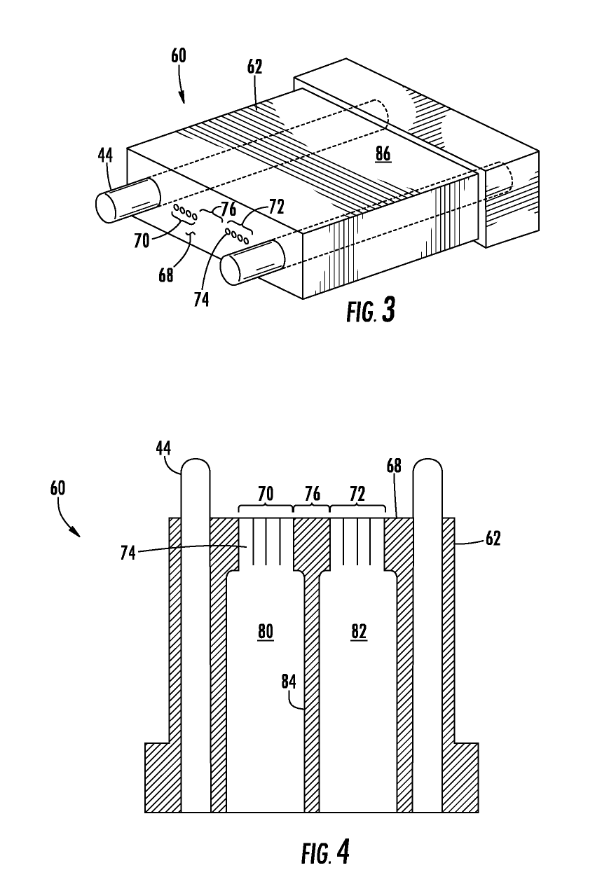

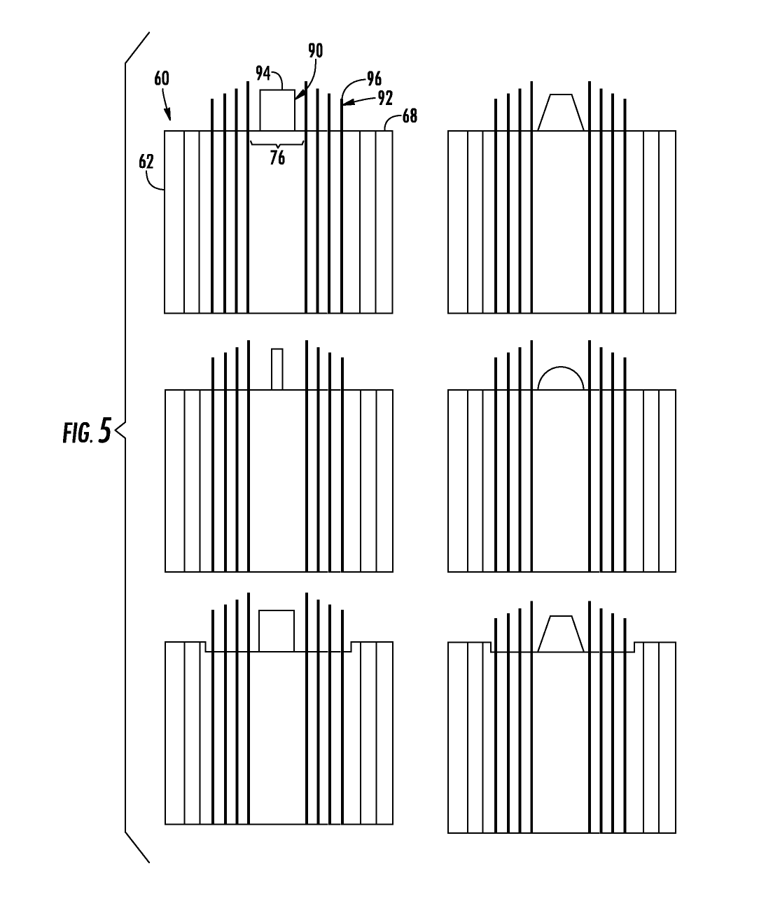

Various embodiments will be further clarified by examples in the description below. In general, the description relates to multi-fiber ferrules and fiber optic connectors, cable assemblies, and methods incorporating such multi-fiber ferrules. The fiber optic connectors may be based on known connector designs, such as MPO connectors. To this end, FIGS. 1 and 2 illustrate a fiber optic connector 10 (also referred to as “optical connector” or simply “connector”) in the form of a MTP® connector, which is particular type of MPO connector (MTP® is a trademark of US Conec Ltd.). A brief overview of the connector 10 will be provided to facilitate discussion, as the multi-fiber ferrules shown in subsequent figures may be used in connection with the same type of connector. However, persons skilled in the field of optical connectivity will appreciate that the connector 10 is merely an example, and that the general principles disclosed with respect to the multi-fiber ferrules shown in subsequent figures may also be applicable to other connector designs.

As shown in FIG. 1, the connector 10 may be installed on a fiber optic cable 12 (“cable”) to form a fiber optic cable assembly 14. The connector includes a ferrule 16, a housing 18 received over the ferrule 16, a slider 20 received over the housing 18, and a boot 22 received over the cable 12. The ferrule 16 is spring-biased within the housing 18 so that a front portion 24 of the ferrule 16 extends beyond a front end 26 of the housing 18. Optical fibers (not shown) carried by the cable 12 extend through micro-holes or bores 28 in the ferrule 16 before terminating at or near an end face 30 of the ferrule 16. The optical fibers are secured within the ferrule 16 using an adhesive material (e.g., epoxy) and can be presented for optical coupling with optical fibers of a mating component (e.g., another fiber optic connector; not shown) when the housing 20 is inserted into an adapter, receptacle, or the like.

As shown in FIG. 2, the connector 10 also includes a ferrule boot 32, guide pin assembly 34, spring 36, crimp body 38, and crimp ring 40. The ferrule boot 32 is received in a rear portion 42 of the ferrule 16 to help support the optical fibers extending to the ferrule bores 28 (FIG. 1). The guide pin assembly 34 includes a pair of guide pins 44 extending from a pin keeper 46. Features on the pin keeper 46 cooperate with features on the guide pins 44 to retain portions of the guide pins 44 within the pin keeper 46. When the connector 10 is assembled, the pin keeper 46 is positioned against a back surface of the ferrule 16, and the guide pins 44 extend through pin holes 48 (FIG. 1) provided in the ferrule 16 so as to project beyond the front end face 30.

Both the ferrule 16 and guide pin assembly 34 are biased to a forward position relative to the housing 18 by the spring 36. More specifically, the spring 36 is positioned between the pin keeper 46 and a portion of the crimp body 38. The crimp body 38 is inserted into the housing 18 when the connector 10 is assembled and includes latching arms 50 that engage recesses 52 in the housing. The spring 36 is compressed by this point and exerts a biasing force on the ferrule 16 via the pin keeper 46. The rear portion 42 of the ferrule defines a flange that interacts with a shoulder or stop formed within the housing 18 to retain the rear portion 42 within the housing 18.

In a manner not shown in the figures, aramid yarn or other strength members from the cable 12 are positioned over an end portion 54 of the crimp body 38 that projects rearwardly from the housing 18. The aramid yarn is secured to the end portion 54 by the crimp ring 40, which is slid over the end portion 54 and deformed after positioning the aramid yarn. The boot 22 covers this region, as shown in FIG. 1, and provides strain relief for the optical fibers by limiting the extent to which the connector 10 can bend relative to the cable 12. The word “PUSH” is printed on the boot 22 in the embodiment shown to help direct a user to grasp the boot 22 when inserting the connector 10 into an adapter or receptacle, thereby allowing the housing to be fully inserted for proper engagement/mating with the adapter or receptacle. The word “PULL” is printed on the slider 20, which may be biased by springs 56 (FIG. 2) relative to the housing 18, to help direct a user to grasp the slider 20 when disengaging the connector 10 from an adapter or receptacle. This way pull forces are transferred directly to the housing 18 (rather than the cable 12) to disengage the housing 18 from the adapter or receptacle.

Now that a general overview of the connector 10 has been provided, alternative ferrule designs will be described. To this end, FIGS. 1 and 2 illustrate a ferrule 60 according to an alternative embodiment. Guide pins 44 are schematically illustrated as well, but other components of the connector 10 are not shown for clarity.

The ferrule 60 includes a body 62 extending in a longitudinal direction (i.e., along a longitudinal axis) between front and back ends of the body 62. The front end defines a front end face 68. First and second groups 70, 72 of micro-holes 74 extend into the body 62 from the front end face 68. Each micro-hole 74 is configured to receive an optical fiber (not shown), similar to the micro-holes 28 of the ferrule 16. In the embodiment of FIGS. 1 and 2, however, the first and second groups 70, 72 of micro-holes 74 are spaced apart from each other by distance greater than spacing between the micro-holes 74 in the first and second groups 70, 72 themselves. Thus, a space 76 is defined between an innermost micro-hole 74 in the first group 70 and an innermost micro-hole 74 in the second group 72, with the space 76 itself being free of micro-holes.

As shown in FIG. 2, the micro-holes 74 open into respective first and second chambers 80, 82 extending into the body 62 from the back end of the ferrule 60. A partition 84 separates the first and second chambers 80, 82. In alternative embodiments, the micro-holes 74 may open into a common chamber. Embodiments are also possible where the micro-holes 74 extend completely though the ferrule 60 (i.e., between the front end and back end of the ferrule 60). An advantage of providing the first and second chambers 80, 82, however, is that the first and second chambers 80, 82 can each be configured to accommodate a four-fiber ribbon (not shown). Only a short length of the ribbon needs to be stripped of ribbon matrix material to expose the four optical fibers so that, once cleaned, the optical fibers can extend into the micro-holes 74. Features can also be provided in the first and second chambers 80, 82 to help guide the optical fibers into the respective micro-holes 74 during insertion. Handling a four-fiber ribbon to align four optical fibers with four micro-holes is easier than the conventional approach of handling a 12-fiber ribbon to align 12 fibers with 12 micro-holes.

The body 62 of the ferrule 60 includes an outer surface 86 (FIG. 1) extending between the front and back ends of the body 62. In a manner not shown, the ferrule 60 may include one or more openings extending through the outer surface 86 of the body 62 so that an adhesive material may be applied to optical fibers received in the body 62. For example, a first opening may extend through the outer surface 86 of the body 62 to the first chamber 80 (and/or first group 70 of micro-holes 74), and a second opening may extend through the outer surface 86 to the second chamber 82 (and/or second group 70 of micro-holes 74). Alternatively, a common opening may extend through the outer surface 86 to the first and second chambers 80, 82 (and/or first and second groups 70, 72 of micro-holes 74). With the first and second chambers 80, 82 defining a smaller overall volume within the body 62 compared to a common chamber, the amount of adhesive material required to bond the optical fibers is reduced. In some embodiments, the body 62 may be over-molded directly onto the optical fibers such no adhesive material (or openings in the outer surface 86 for such adhesive material) is required.

There are four micro-holes 74 in each of the first and second groups 70, 72 in the embodiment shown. Thus, the ferrule 60 is designed to accommodate 8 optical fibers. Such a configuration is particularly suited for parallel optics applications for 40 Gps transmission in that there are no unused optical fibers or empty micro-holes. In alternative embodiments, the first and second groups 70, 72 may have a different number of micro-holes 74, such as 10 each. The first group 70 may even have a different number of micro-holes 74 than the second group 72 in some embodiments. Furthermore, the micro-holes 74 in each of the first and second groups 70, 72 may be arranged in a line (as shown), array, or any other pattern on the front end face 68 of the ferrule 60.

Additional advantages may be obtained by providing the ferrule 60 with a pedestal extending from the front end face 68 between the first and second groups 70, 72 of micro-holes 74. To this end, FIG. 5 schematically illustrates several embodiments of the ferrule 60 including a pedestal 90. Although the micro-holes 74 are not shown, optical fibers 92 received by the micro-holes 74 are such that the presence of the micro-holes 74 will be appreciated. And although a single pedestal 90 is shown, additional pedestals may be provided if desired, and be located anywhere on the first end face 68. The pedestal 90 may be various shapes, such as prismatic (e.g., rectangular in cross-section), a frustum (i.e., truncated cone), or spherical. Particular advantages may be associated with narrow shapes and/or shapes where the pedestal 90 reduces in cross-section as the pedestal 90 extends in the longitudinal direction from the first end face 68.

In the embodiments shown, the pedestal 90 occupies only a portion of the space 76 between the first and second groups 70, 72 of micro-holes 74. More specifically, the first and second groups 70, 72 of micro-holes 74 each have a first width measured between respective innermost and outermost micro-holes 74 of the first and second groups 70, 72. The micro-holes 74 may be in a row transverse to the longitudinal direction. The pedestal 90 has a maximum width less than the first width, measured in the same direction as the first width (i.e., in the transverse direction).

The presence of the pedestal 90 allows quick visualization to determine that the ferrule 60 and/or connector including the ferrule 60 have something other than a conventional, 12-fiber count/arrangement. Particular geometries may be associated with particular fiber counts to further assist with the determination (e.g., a first pedestal shape may indicate an 8-fiber count, a second pedestal shape may indicate a 10-fiber count, and so on . . . ). The determination can easily be made even when a connector is assembled, as the front end face 68 of the ferrule 60 remains visible through a front opening of a housing in most connector designs.

Perhaps more importantly, the pedestal 90 serves as a reference during fiber insertion to facilitate the cable assembly process and during mating to improve optical coupling. In particular, the pedestal 90 defines a second end face 94 having at least a portion offset from the first end face 68 in the longitudinal direction of the ferrule 60. The offset may be between about 5 μm and about 50 um, or even between about 10 μm and about 30 μm in some embodiments. To install the ferrule 60 on the optical fibers 92, the optical fibers 92 are inserted into the back end of the ferrule 60 and through the first and second groups 70, 72 of micro-holes 74. This results in the optical fibers 92 extending beyond the first end face 68, and perhaps even beyond a plane that is transverse to the longitudinal direction and that includes the second end face 94.

A reference surface (not shown) is then brought into contact with the second end face 94. If the optical fibers 92 previously extended past the plane including the second end face 94, the reference surface contacts the optical fibers 92 before the reference surface is brought into contact with the second end face 94. By this point, the optical fibers 92 have been pushed back in the longitudinal direction so that ends 96 of the optical fibers 92 are positioned in substantially the same plane as the second end face 94. If the optical fibers did not previously extend to the plane including the second end face 94, the optical fibers 92 can be moved further through the ferrule 60 so that their ends 96 contact the reference surface. Either way results in the reference surface contacting both the ends 96 of the optical fibers 94 and the second end face 94.

While the optical fibers 92 and second end face 94 remain in contact with the reference surface, the optical fibers 92 are secured in the ferrule 60. For example, an adhesive material (e.g., epoxy) may be inserted into the ferrule 60 in the manner described above before or after positioning the optical fibers 92. The adhesive material is ultimately cured while the reference surface is held in contact with the optical fibers 92 and the second end face 94. In this manner, the offset of the second end face 94 effective sets an initial protrusion height of the optical fibers 92 from the first end face 68.

Eventually the reference surface is moved away from the optical fibers 92 and ferrule 60, or vice-versa, making the ends 96 of the optical fibers 92 and the second end face 94 accessible. The second end face 94 and ends 96 of the optical fibers 92 are then polished. The material of the ferrule 60 may be softer than the material of the optical fibers 92 such that the polishing preferentially removes material of the pedestal 90. Accordingly, the ends 96 of the optical fibers 92 protrude past a plane including the second end face 94 (or outermost portion of the second end face 94 relative to the first end face 68) after the polishing. In some embodiments, the optical fibers 92 protrude less about 3 μm past the plane.

As can be appreciated, the amount of material removed during the polishing process described above is minimal due to the small size of the pedestal 90 (and specifically, the small area of the second end face 94). This may enable short, less-aggressive polishing processes that reduce processing time. For example, it may be possible to complete the polishing in less than three steps involving successively finer polishing films, or even in a single step involving a very fine polishing film. Additionally, the use of the reference surface and minimal polishing may result in better co-planarity between the ends 96 of the optical fibers 92, which helps ensure physical contact with other optical fibers when mated.

Another advantage associated with the pedestal 90 is that the protrusion height of the optical fibers 92 from the first end face 68 is controlled relative to the plane including the second end face 94. Due to the offset of the second end face 94 from the first end face 68, the protrusion height relative to the first end face 68 is larger than what the protrusion height would be without the pedestal 90. Thus, the protrusion height of the optical fibers 90 is relatively large, such as between about 10 μm and about 30 um, to account for the offset of the second end face 94. As a result, the ferrule 60 may be less sensitive to contamination from dust, debris, and other particulates around the optical fibers 92. The second end face 94 serves as a contact surface of the ferrule 60 when the ferrule 60 is mated with another component, and due to the relatively small surface area of the second end face 94, the potential for particulates to interfere with the mating and prevent physical contact between the optical fibers is reduced.

Persons skilled in optical connectivity will appreciate additional variations and modifications of the devices and methods already described. For example, any of the ferrules mentioned above may be mated to ferrules having the same configuration or a conventional configuration. Additionally, where a method claim below does not explicitly recite a step mentioned in the description above, it should not be assumed that the step is required by the claim. Furthermore, where a method claim below does not actually recite an order to be followed by its steps or an order is otherwise not required based on the claim language, it is no way intended that any particular order be inferred.

What is claimed is:

1. A ferrule for an optical connector that can include multiple optical fibers, the ferrule comprising:
a body extending in a longitudinal direction between a front end and a back end, the front end defining a first end face and a pedestal extending from the first end face in the longitudinal direction; and
first and second groups of micro-holes extending into the body from the first end face, each micro-hole being configured to receive one of the optical fibers;
wherein the pedestal is positioned between the first and second groups of micro-holes.

2. A ferrule according to claim 1, wherein the first and second groups of micro-holes are spaced apart from each other by distance greater than spacing between the micro-holes in the first and second groups themselves.

3. A ferrule according to claim 1, wherein the pedestal defines a second end face offset from the first end face in the longitudinal direction, the first and second groups of micro-holes each having a first width measured between respective innermost and outermost micro-holes of the first and second groups, the second end face having a second width measured in the the same direction as the first widths, the second width being less than the first widths.

4. A ferrule according to claim 1, wherein the pedestal reduces in cross-section as the pedestal extends in the longitudinal direction from the first end face.

5. A ferrule according to claim 1, wherein the pedestal has prismatic, frustum, or spherical shape.

6. A ferrule according to claim 1, wherein the pedestal defines a second end face offset from the first end face by a first distance between about 5 μm and about 50 μm in the longitudinal direction.

7. A ferrule according to claim 6, wherein the first distance is between about 10 μm and about 30 um.

8. A ferrule according to claim 1, further comprising:
at least one chamber extending into the body from the back end, wherein the first and second groups of micro-holes open into the chamber.

9. A ferrule according to claim 8, wherein the at least one chamber comprises a first chamber and second chamber such that the body defines a partition between the first and second chambers, the first group of micro-holes opening into the first chamber, and the second group of micro-holes opening into the second chamber.

10. A ferrule according to claim 9, further comprising:
an outer surface on the body between the front end and the back end;
a first opening extending through the outer surface to the first chamber; and
a second opening extending through the outer surface to the second chamber.

11. A fiber optic connector that can include multiple optical fibers, the fiber optic connector comprising:
a ferrule comprising:
a body extending in a longitudinal direction between a front end and a back end, the front end defining a first end face and a pedestal extending from the first end face in the longitudinal direction; and
first and second groups of micro-holes extending into the body from the first end face, each micro-hole being configured to receive one of the optical fibers, wherein the pedestal is positioned between the first and second groups of micro-holes; and
a housing received over the ferrule, wherein the ferrule is spring-biased within the housing so that the front end of the body of the ferrule extends beyond the housing.

12. A fiber optic cable assembly, comprising:
a ferrule comprising:
a body extending in a longitudinal direction between a front end and a back end, the front end defining a first end face and a pedestal extending from the first end face in the longitudinal direction, and the pedestal defining a second end face offset from the first end face in the longitudinal direction; and
first and second groups of micro-holes extending into the body from the first end face, wherein the pedestal is positioned between the first and second groups of micro-holes; and
optical fibers each received in one of the micro-holes of the ferrule, wherein the optical fibers extend past the first end face to or beyond a transverse plane including the second end face.

13. A method of installing a ferrule on a plurality of optical fibers, wherein the ferrule includes a body extending in a longitudinal direction between a front end and a back end of the ferrule, first and second groups of micro-holes extending into the body from a first end face defined by the front end, and a pedestal extending from the first end face in the longitudinal direction, the pedestal being positioned between the first and second groups of micro-holes and defining a second end face offset from the first end face in the longitudinal direction, the method comprising:
inserting the optical fibers into the back end of the ferrule and through the first and second groups of micro-holes such that the optical fibers extend beyond the first end face;
contacting a reference surface with the optical fibers and with the second end face of the pedestal;
securing the optical fibers in the ferrule while the optical fibers and second end face remain in contact with the reference surface; and
polishing the second end face to remove material of the pedestal so that ends of the optical fibers protrude past a transverse plane including the second end face.

14. A method according to claim 13, wherein the second end face is offset from the first end face by a first distance between about 5 μm and about 50 μm in the longitudinal direction after polishing such that the optical fibers protrude from the first end face by at least the first distance.

15. A method according to claim 14, wherein the first distance is between about 10 μm and about 30 um.

16. A method according to claim 13, wherein the optical fibers protrude less than about 3 μm past the transverse plane including the second end face after polishing the second end face.
